(19) United States
(12) Patent Application Publication
(10) Pub. No.: US 2020/0100488 A1
(43) Pub. Date: Apr. 2, 2020

(54) FISHING ALERT ASSEMBLY

(71) Applicant: Damion Judd, Columbus, OH (US)

(72) Inventor: Damion Judd, Columbus, OH (US)

(21) Appl. No.: 16/149,110

(22) Filed: Oct. 1, 2018

(51) Int. Cl. A01K 97/12; G08B 3/02

(52) U.S. Cl. CPC A01K 97/12; G08B 3/02

(57) ABSTRACT

A fishing alert assembly for alerting a fisherman to a fish on a fishing pole includes a fishing pole and a cylinder that is removably coupled to the fishing pole. The cylinder is positioned on an opposite side of the fishing pole with respect to a fishing line thereby inhibiting the cylinder from engaging the fishing line. A plurality of bells is provided and each of the bells is positioned within the cylinder. Each of the bells rings when the cylinder is agitated to emit an audible alert when a fish tugs on the fishing pole.

### CROSS-REFERENCE TO RELATED APPLICATIONS

### STATEMENT REGARDING FEDERALLY SPONSORED RESEARCH OR DEVELOPMENT

### Not Applicable

### THE NAMES OF THE PARTIES TO A JOINT RESEARCH AGREEMENT

### Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### STATEMENT REGARDING PRIOR DISCLOSURES BY THE INVENTOR OR JOINT INVENTOR

### Not Applicable

### BACKGROUND OF THE INVENTION

### (1) Field of the Invention

### (2) Description of Related Art Including Information Disclosed Under 37 CFR 1.97 and 1.98

The disclosure and prior art relates to alert devices and more particularly pertains to a new alert device for alerting a fisherman to a fish on a fishing pole.

### BRIEF SUMMARY OF THE INVENTION

An embodiment of the disclosure meets the needs presented above by generally comprising a fishing pole and a cylinder that is removably coupled to the fishing pole. The cylinder is positioned on an opposite side of the fishing pole with respect to a fishing line thereby inhibiting the cylinder from engaging the fishing line. A plurality of bells is provided and each of the bells is positioned within the cylinder. Each of the bells rings when the cylinder is agitated to emit an audible alert when a fish tugs on the fishing pole.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of cylinder of a fishing alert assembly according to an embodiment of the disclosure.

FIG. 2 is a top view of cylinder of an embodiment of the disclosure.

FIG. 3 is a cross sectional view taken along line 3-3 of FIG. 2 of an embodiment of the disclosure.

FIG. 4 is a perspective in-use view of an embodiment of the disclosure.

### DETAILED DESCRIPTION OF THE INVENTION

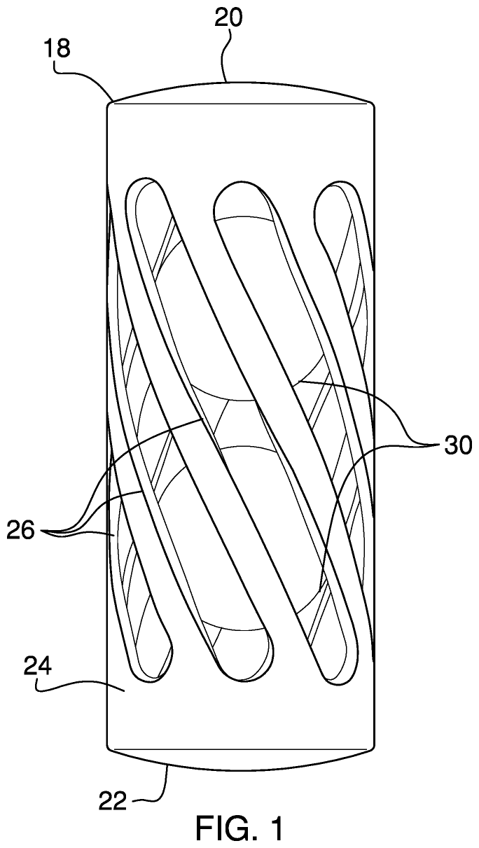

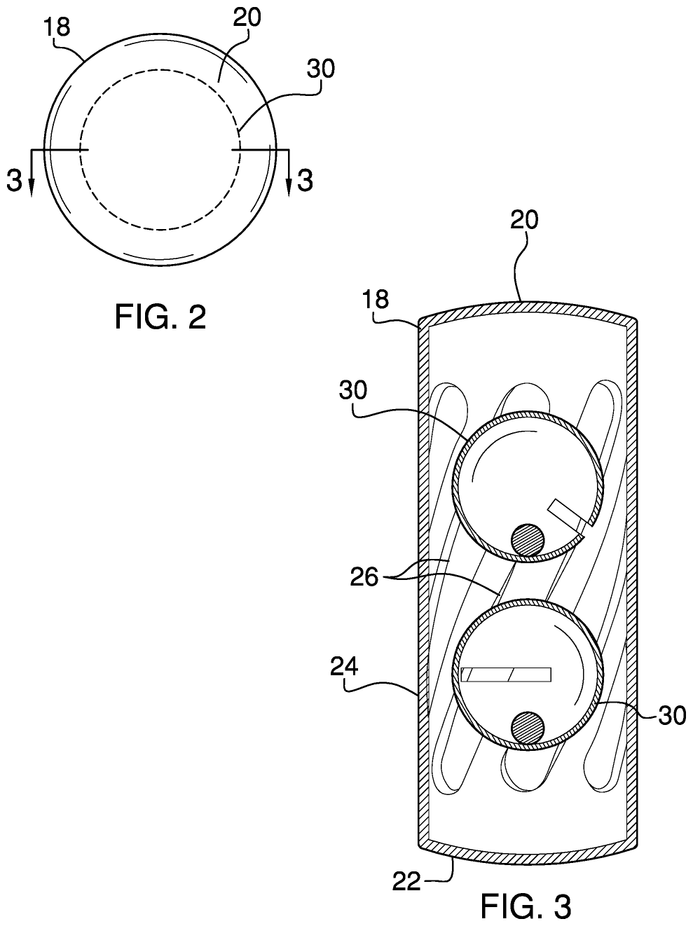

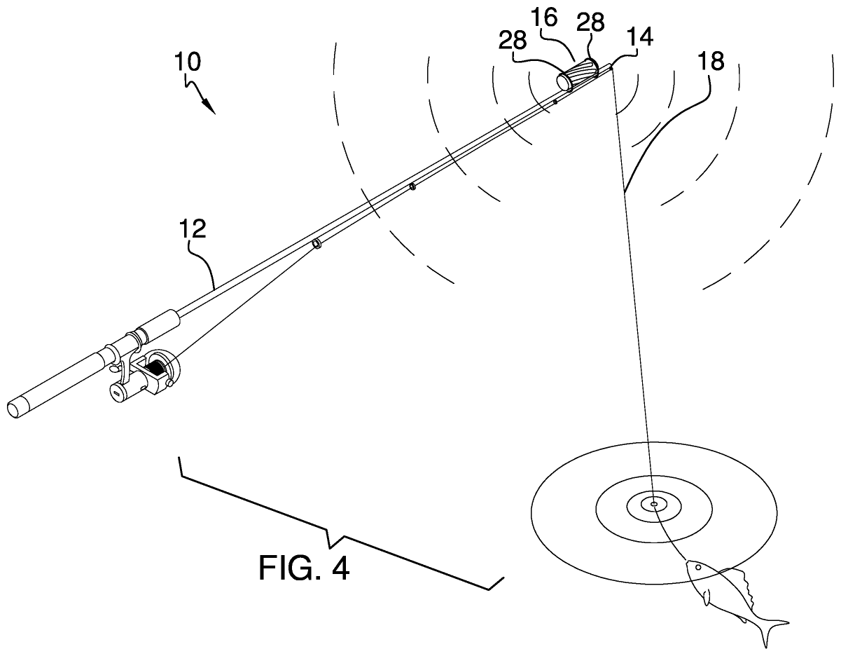

With reference now to the drawings, and in particular to FIGS. 1 through 4 thereof, a new alert device embodying the principles and concepts of an embodiment of the disclosure and generally designated by the reference numeral 10 will be described.

As best illustrated in FIGS. 1 through 4, the fishing alert assembly 10 generally comprises a fishing pole 12 that has a distal end 14. The fishing pole 12 may be a fishing pole 12 of any conventional design and length. Moreover, the fishing pole 12 may employ any type of fishing reel and any type of fishing line 18. A cylinder 16 is removably coupled to the fishing pole 12 and the cylinder 16 is aligned with the distal end 14. The cylinder 16 is positioned on an opposite side of the fishing pole 12 with respect to a fishing line 18 thereby inhibiting the cylinder 16 from engaging the fishing line 18. In this way the fishing line 18 can be cast and retrieved in a normal fashion when the cylinder 16 is attached to the fishing pole 12.

The cylinder 16 has a first end 20, a second end 22 and an outer wall 24 extending therebetween, and the cylinder 16 is hollow. The outer wall 24 has a plurality of slots 26 extending into an interior of the cylinder 16 and each of the slots 26 extends substantially between the first 20 and second 22 ends. The slots 26 are spaced apart from each other and are distributed around the cylinder 16. Moreover, each of the slots 26 wraps partially around the outer wall 24 of the cylinder 16 such that the plurality of slots 26 forms a spiral shape.

A pair of mating members 28 is provided and each of mating members 28 wraps around the cylinder 16 and the fishing pole 12 to releasably retain the cylinder 16 on the fishing pole 12. Each of the mating members 28 may comprise a zip tie, a pair of Velcro straps or other releasable, deformable mating member. A plurality of bells 30 is provided and each of the bells 30 is positioned within the cylinder 16. Each of the bells 30 rings when the cylinder 16 is agitated thereby emitting an audible alert when a fish tugs on the fishing pole 12. Each of the bells 30 may be jingle bells or other bells 30 that have a self contained striker.

In use, the cylinder 16 is positioned on the fishing pole 12 and each of the mating members 28 is wrapped around the cylinder 16 and the fishing pole 12. Moreover, the cylinder 16 is positioned on an opposite side of the fishing pole 12 with respect to the fishing line 18 on the fishing pole 12. Thus, the fishing line 18 can be cast and retrieved without engaging the cylinder 16. The bells 30 in the cylinder 16 ring when a fish tugs on the fishing pole 12 thereby emitting an audible alert for a fisherman.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing alert assembly being configured to emit an audible alert when a fish bites a fishing line, said assembly comprising:
a fishing pole having a distal end;
a cylinder being removably coupled to said fishing pole having said cylinder being aligned with said distal end, said cylinder being positioned on an opposite side of said fishing pole with respect to a fishing line thereby inhibiting said cylinder from engaging said fishing line; and
a plurality of bells, each of said bells being positioned within said cylinder, each of said bells ringing when said cylinder is agitated wherein said bells are configured to emit an audible alert when a fish tugs on said fishing pole.

2. The assembly according to claim 1, wherein said cylinder has a first end, a second end and an outer wall extending therebetween, said cylinder being hollow, said outer wall having a plurality of slots extending into an interior of said cylinder, each of said slots extending substantially between said first and second ends, said slots being spaced apart from each other and being distributed around said cylinder, each of said slots wrapping partially around said outer wall of said cylinder.

3. A fishing alert assembly being configured to emit an audible alert when a fish bites a fishing line, said assembly comprising:
a fishing pole having a distal end;
a cylinder being removably coupled to said fishing pole having said cylinder being aligned with said distal end, said cylinder being positioned on an opposite side of said fishing pole with respect to a fishing line thereby inhibiting said cylinder from engaging said fishing line, said cylinder having a first end, a second end and an outer wall extending therebetween, said cylinder being hollow, said outer wall having a plurality of slots extending into an interior of said cylinder, each of said slots extending substantially between said first and second ends, said slots being spaced apart from each other and being distributed around said cylinder, each of said slots wrapping partially around said outer wall of said cylinder; and
a plurality of bells, each of said bells being positioned within said cylinder, each of said bells ringing when said cylinder is agitated wherein said bells are configured to emit an audible alert when a fish tugs on said fishing pole.
